(19) United States
(12) Patent Application Publication
(10) Pub. No.: US 2012/0280093 A1
(43) Pub. Date: Nov. 8, 2012

(54) CHAIR MAT DISPLAY

(75) Inventors: Jerry Alicea, Twinsburg, OH (US); Patrick Foley, Indianapolis, IN (US); Danielle Rodgers, Indianapolis, IN (US)

(73) Assignee: DEFLECTO, LLC, Indianapolis, IN (US)

(21) Appl. No.: 13/102,480

(22) Filed: May 6, 2011

(51) Int. Cl. F16M 11/04; G09F 15/00

(52) U.S. Cl. 248/121; 40/606.01; 40/611.01

(57) ABSTRACT

A display comprising a base, a backboard attached to the base, a bracket mount attached to the front side of the backboard, and at least one removable bracket attached to the bracket mount.

### FIELD OF THE INVENTION

The present inventive concept generally relates to a display stand for various merchandise samples. In particular, the invention relates to a display stand to which one or more material samples are mounted in a manner that permits a viewer to easily browse each sample.

### BACKGROUND OF THE INVENTION

Various display stands are known in the art that permit a viewer to browse through individual samples for various merchandise including, floor materials, wallpaper, carpets, chair mat materials, fabrics and the like. These display stands can be bulky and take up a significant amount of space on the counter-top or the floor where they are placed. In addition, the known display stands make it difficult to browse through samples without having to start at the beginning or end of the samples that are displayed on a particular stand.

What is needed, therefore, is a display stand that has a reduced size and permits a viewer to easily browse individual samples.

### SUMMARY OF THE INVENTION

The present invention relates to a display stand for various merchandise samples. Specifically, the display stand can sit upright on a counter or be mounted on a floor pedestal.

In one embodiment of the invention the display stand includes a base, a backboard attached to the base, a bracket mount attached to the front side of the backboard and at least one removable bracket attached to the bracket mount.

In another embodiment of the invention, the display stand includes an information panel display attached to the upper surface of the base. The information panel display can be attached to the upper surface of the base with an information panel mount. Additionally, the information panel mount can have an incline that is effective to display the information panel display at an angle relative to the upper surface of the base. Furthermore, an information graphic, which may be removable, can be attached to the information panel display.

In another embodiment of the invention, the bracket includes comprises a sample holder configured to hold a sample of a material such as wallpaper, floor materials, carpet, fabric or the like. More specifically, the sample holder can be configured to hold a sample of a chair mat material. Additionally, the sample holder can be configured to hold a sample and a literature panel. The literature panel can include information that identifies and provides details about the sample held within the sample holder.

In another embodiment of the invention, the display base includes a floor stand mount attached to the underside of the base, a receiving means for a pole attached to the floor stand mount, a pole held by the receiving means and a floor pedestal connected to the floor stand mount via the pole. In this embodiment, the display device can be displayed using a floor stand.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate presently preferred embodiments of the invention and, together with the description, serve to explain the advantages and principles of the invention. In the drawings:

FIG. 1: Display showing range of motion of the brackets.

FIG. 2: Exploded drawing of display, showing its individual parts.

FIG. 3: Rear-view display with bracket and attachment means.

FIG. 4: Exploded drawing of the Rear-view of display.

FIG. 5: Bracket mount.

FIG. 6: Right-side perspective of bracket

FIG. 7: Left-side view of bracket.

FIG. 8: Bottom view of bracket.

FIG. 9: Right-side perspective of bracket with sample and literature panel.

FIG. 10: Right-side view of bracket.

FIG. 11: Bottom view of bracket.

FIG. 12: Left-side view of bracket.

FIG. 13: Right-side perspective of bracket with sample and literature panel.

FIG. 14: Information panel mount.

FIG. 15: Underside of display base with floor-stand attachment.

FIG. 16: Display with floor stand.

### DETAILED DESCRIPTION OF THE PRESENTLY PREFERRED EMBODIMENTS

The presently preferred embodiments according to principles of the present invention will be described in detail hereinafter with reference to the accompanying figures. Although the presently preferred embodiments of the present invention will be described below with various technically preferred limitations, the scope of the present invention is not limited thereto unless otherwise described below.

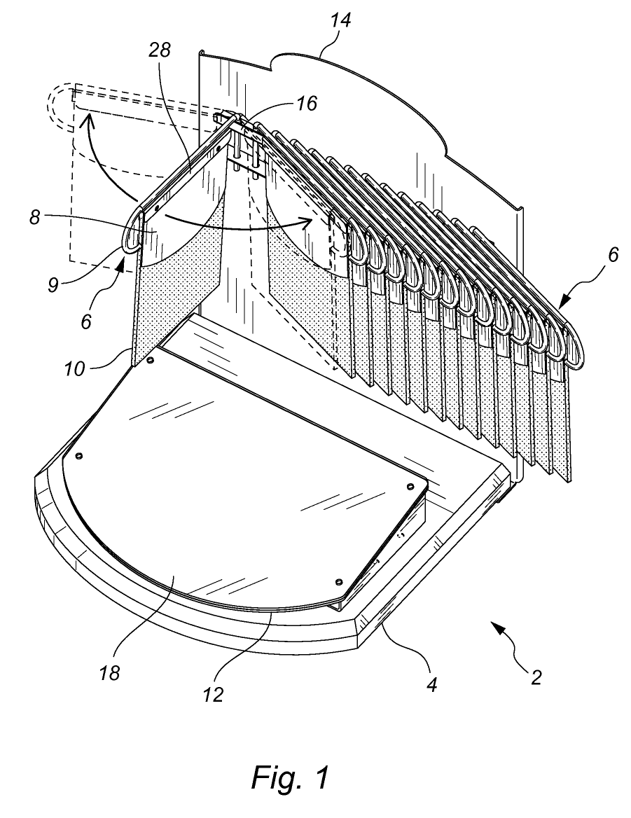

FIG. 1 illustrates a display (2) according to principles of the present invention. The display (2) includes a base (4), which can be placed on a countertop, shelf or other surface. The base can be made of any suitable material known to a person of ordinary skill in the art including, various plastics, wood, metal, or the like and recycled versions of the same. An information display panel (12) is attached to the upper surface of the base. Similarly, the information display panel (12) can be made of any suitable material known to a person of ordinary skill in the art including plastics, wood metal or the like and recycled versions of the same. A backboard (14), which can be made of any suitable material known to a person of ordinary skill in the art including, various plastics, wood, metal, or the like and recycled versions of the same, extends upwards from the base (4) and is attached to the base (4) in a manner that is sufficient to support the weight of each sample (10). For example, the backboard could be attached to the base using brackets, screws, nails or the like. The shape of the backboard, information display panel and base are not limited to those shown in FIG. 1. Indeed, the shapes of the backboard, information display panel and base can be square, rectangular, circular, oval, a free form shape or the like.

A bracket mount (16), is attached to the backboard (14). The bracket mount can be made of any suitable material known to a person of ordinary skill in the art including, various plastics, wood, metal, or the like and recycled versions of the same. The bracket mount can be any shape or configuration that can hold an individual bracket (6) or multiple brackets. For example, the bracket mount can be one row or multiple rows where each row has a receiving means for an individual bracket. The individual brackets (6) are removably attached to the backboard (14) via a bracket mount (16). Additionally, the individual brackets are attached to the bracket mount in a manner that permits each individual bracket to freely move from left to right and right to left.

Each sample (10) is attached to the bracket via a sample holder (28). The sample holder (28) can be configured to hold various types of samples including floor materials, wallpaper, carpets, chair mat materials, fabrics and the like. Additionally, a literature panel (8) that extends over a portion of the sample (10) and which can be used to display information can be held by or secured to the sample holder (28). A tab (9) extends outward from the bracket (6). The tab (9) can contain information, for example information to identify a particular sample. The tab can also serve as a handle to permit a view to easily browse or view each sample.

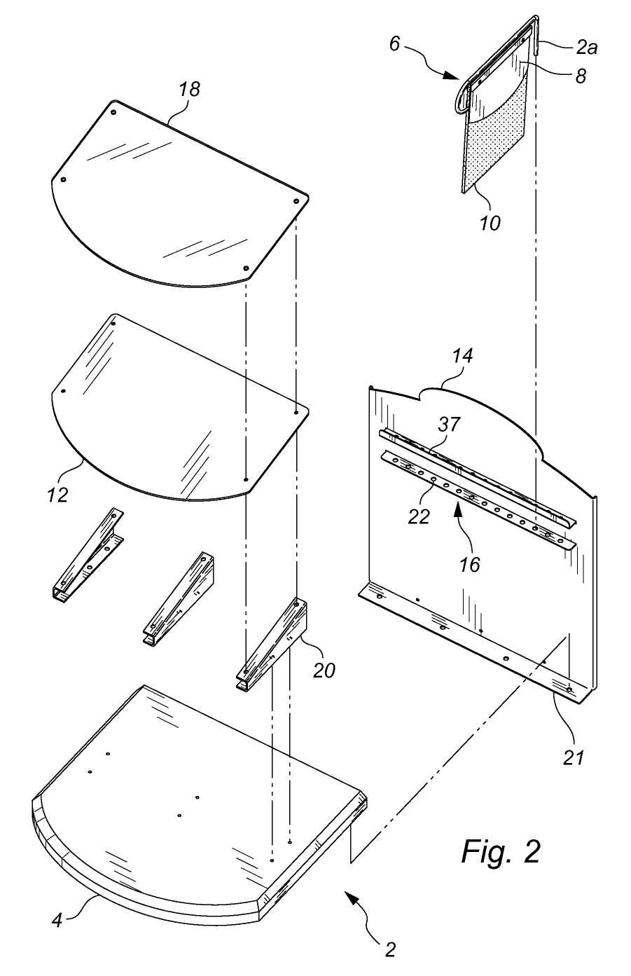

FIG. 2 illustrates a display (2) according to principles of the present invention. As shown in this figure, information panel mounts (20) are attached to the base (4). These panel mounts can be flat or raised to permit the information panel (12) to display an information graphic (18) at an angle. A lip (21) located at the bottom portion of the backboard (14) and that extends under the base can provide additional stability and support for the backboard (14). The bracket mounts (16) secured to the backboard (14). The bracket mounts (16) have a receiving means (22) that is configured to receive a portion of the bracket (6) so that the bracket (6) is securely attached to the bracket mount (16). In this example, the bracket mount consists of two parallel rows, the upper row having a plurality of receiving means (22), each of which are associated with a receiving means in the lower row. Additionally, in this embodiment, the upper row has a lip (37) that runs along the edge of the bracket facing away from the backboard. This lip (37) can prevent a bracket from slipping out of place.

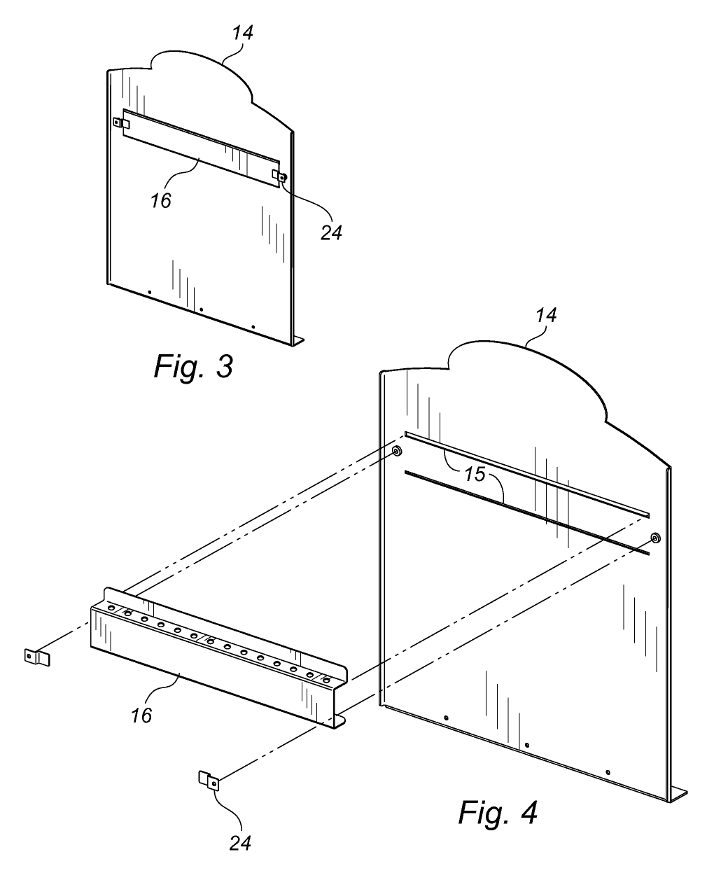

FIG. 3 illustrates a rear view of the backboard (14) and bracket mount (24) according to principles of the present invention. In this figure the bracket (24) is attached to the backboard via any suitable attachment means (26) such as a clip, screw, nail or the like.

FIG. 4 illustrates a rear view of the backboard (14) and bracket mount (24) according to principles of the present invention. In the figure, the backboard has two slot openings (15) through which a portion of the bracket mount (16) extends from the rear side to the front side of the backboard (14). The bracket mount (16) does not have to be attached to the backboard via two slot openings as shown in this figure. For example a bracket mount that attaches to the front side of the backboard can be used. Additionally, a bracket mount that is attached to the bottom of the base or that extends over the top of the backboard can also be used.

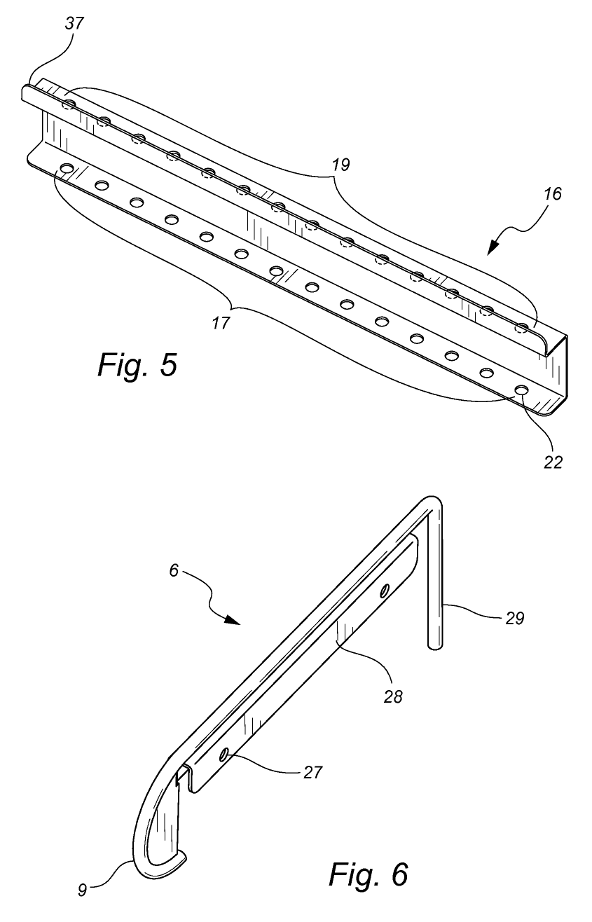

FIG. 5 illustrates the bracket mount (16) according to principles of the present invention. This bracket mount has an upper row (19) and lower row (17) of receiving means (22). Each receiving means (22) in the upper row (19) is associated with a receiving means (22) in the lower row. The bracket mount (16) is not limited to two rows as shown in this figure. The bracket mount (16) could include only one row of receiving means or more than two rows of receiving means. Additionally, in this embodiment, the upper row has a lip (37) that runs along the edge of the bracket facing away from the backboard. This lip (37) can prevent a bracket from slipping out of place.

FIG. 6 illustrates a side view of the bracket (6) according to principles of the present invention. A sample holder (28) is attached to the bracket (6). The sample holder (28) has a width x, that is sufficient to hold a sample and/or a literature panel. One or more openings (27) are located on one or both faces of the sample holder (28). A securing means (not shown) such as a screw, bolt or the like can be used to secure the sample and/or literature panel to the sample holder by inserting the securing means through the opening on one face. The sample does not have to be attached to the sample holder via openings on the face of the sample holder, for example Velcro or an adhesive can be used to attach the sample to the sample holder. If the sample holder (28) has openings on both faces of the sample holder, the securing means extends across from an opening on one face to the associated opening on the opposite face of the sample holder. Additionally, it is not necessary that the sample or the literature holder is permanently attached to the sample holder. For example, a particular sample could be removed from a sample holder and replaced with a different sample. Similarly, the literature holder could be removed and replaced with a different sample.

FIG. 6 also shows an insert (29) located at one end of the bracket (6). The insert (29) is in a shape which can be placed or fit within in a receiving means and the insert (29) extends in a downward direction from the upper portion of the bracket (6). For example, if the receiving means is a circular shape, the insert would have a matching circular shape of slightly smaller diameter to permit the insert to be inserted and removed from the receiving means. The shape of the insert and the corresponding receiving means should also permit the bracket to easily move from right to left and left to right. A tab (9) is located on the end of the bracket that is opposite to the insert (29).

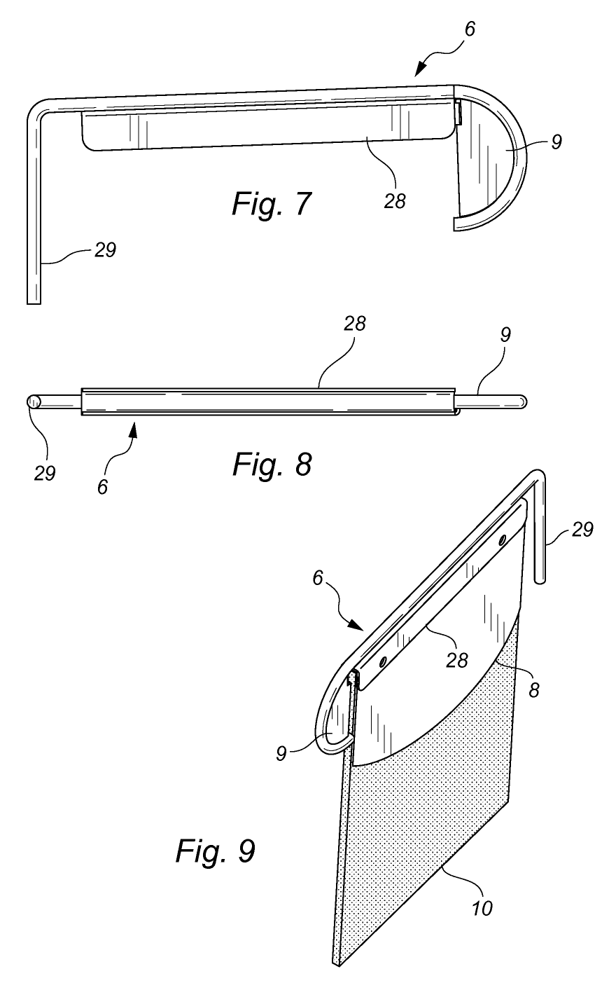

FIG. 7 illustrates a side view of the bracket (6) according to principles of the present invention. In this figure, the tab (9) is formed by a curved portion of the bracket (6) that extends outward from the sample holder (28). The tab is located opposite of the insert (29). The insert (29) in a shape which can be placed in and removed from a receiving means extends in a downward direction from the upper portion of the bracket (6).

FIG. 8 illustrates a downward view of the bracket (6) according to principles of the present invention. In this figure the insert (29), sample holder (28) and tab (9) are shown.

FIG. 9 is a side view of the bracket (6) according to principles of the present invention. In this figure, the literature panel (8), which extends over a portion of the sample (10) is shown. The shape of the literature panel is not limited to that shown in the figure, but should be of such size that permits at least a portion of the sample to be viewed. The literature panel can also extend over the front and/or back side of a sample. If the literature panel extends over both the front and back side of the sample, a viewer can easily view information about a sample from either the right or the left side of the sample. Both the literature panel (8) and the sample (10) are secured within the sample holder (28) by any kind of suitable securing means known to a person of ordinary skill in the art such as a screw, pin, clamp, bracket, Velcro, adhesive or the like.

FIG. 10 is a side view of the bracket (6) in which the sample holder (28) has four sides. The bottom side has a ridge with a width x that is sufficient to hold a bottom edge of a sample. The bottom side of the sample holder does not have to have a ridge as shown in this figure. For example, the ridge does not have to extend along the entire bottom edge of the sample holder, it can extend along a portion or more than one portion of the bottom edge. Additionally, the bottom side of the sample holder can have a surface that is flush with the sample. In this instance, the sample is secured to the flush surface rather than within a ridge. The four sided sample holder (28) allows a flexible material or any other material to be held firmly in place from the top and bottom of the material.

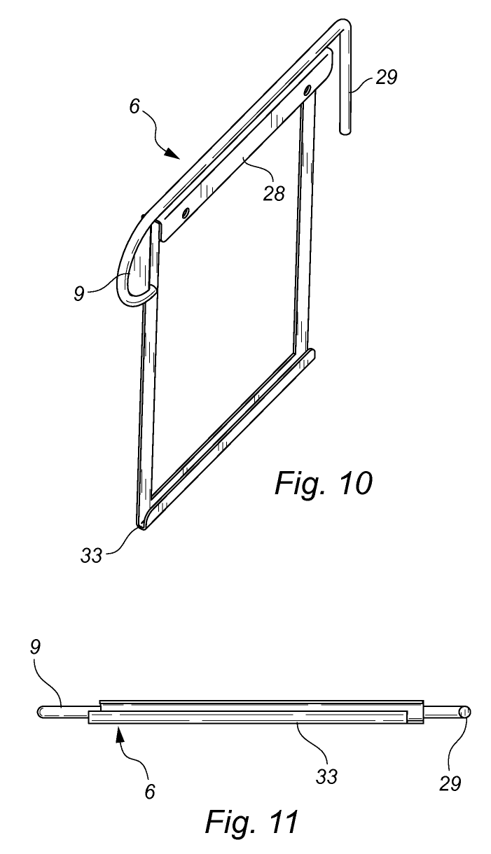

FIG. 11 is a bottom view of the bracket (6) shown in FIG. 9. In this figure the ridge (33), tab (9) and insert (28) are shown.

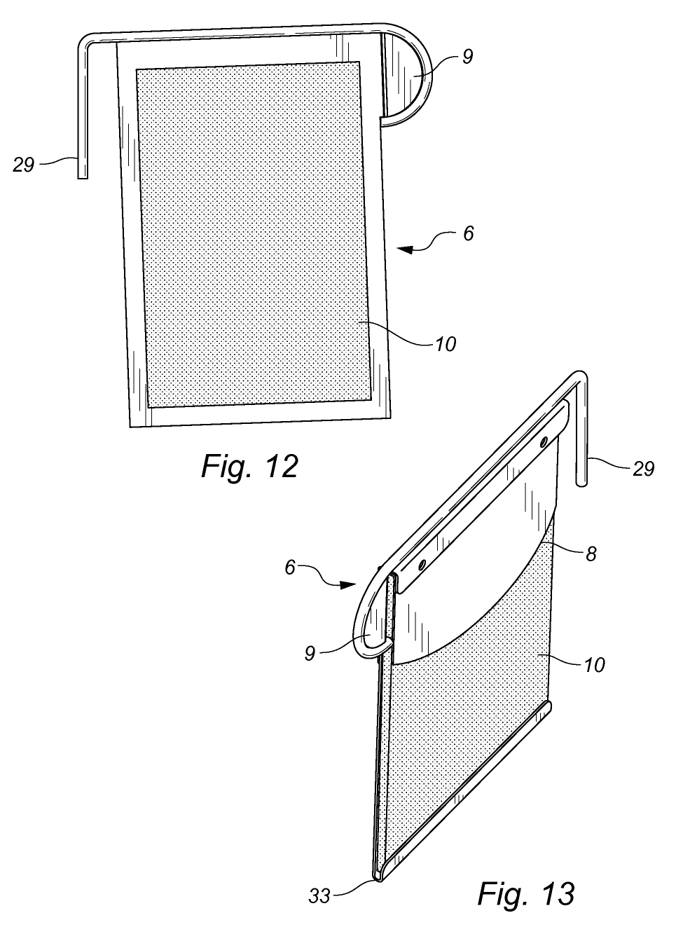

FIG. 12 is a side view of the bracket (6) shown in FIG. 9. In this figure the tab (9), insert (28) are shown.

FIG. 13 is a side view of the bracket (6) according to principles of the present invention. In this figure, the literature panel (8), which extends over a portion of the sample (10) is shown. Both the literature panel (8) and the sample (10) are secured within the four-sided sample holder (28). A portion of the bottom edge of the sample (10) extends within the ridge (33).

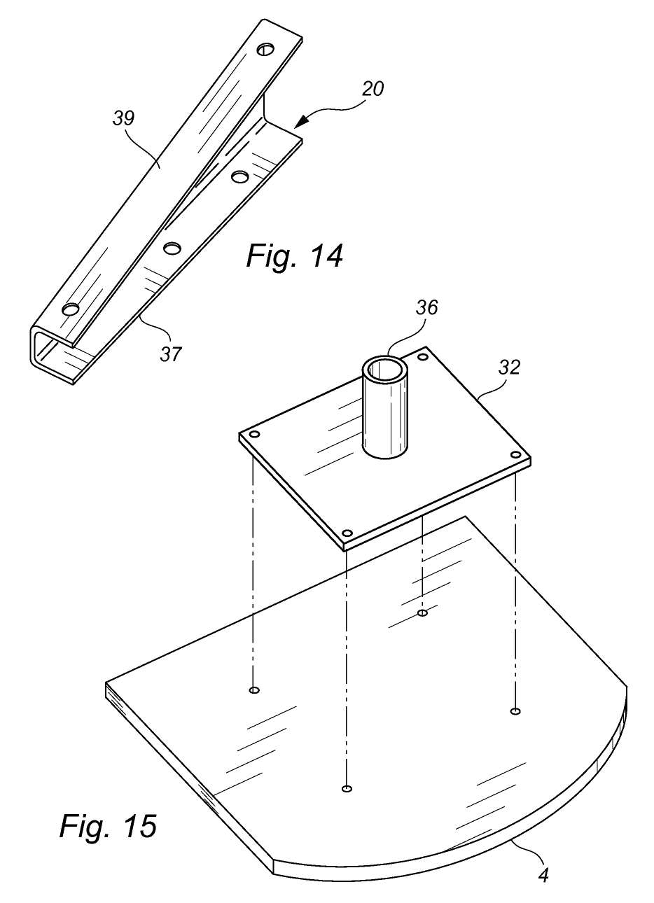

FIG. 14. is a view of the information panel mount (20) according to principles of the present invention. The information panel mount (20) has a bottom edge (37) which can be secured to the base (4) via openings through which a securing means can be inserted. The top edge (39) has openings through which a securing means can be inserted to secure the information panel to the information panel mount. The information panel mount (20) can be of such shape that the information display is shown at an angle with respect to the surface of the base. The information panel mount (20) does not have to display the information display at an angle, it can raise the information display above the base, or merely attach the information display to the base so that it is flush or almost flush with the base.

FIG. 15 is an underside of view of the display base according to principles of the present invention. In this figure a floor-stand mount (32) is attached to the underside of the base (4) via the openings in the underside of the base (4) and corresponding openings in the floor stand mount. Any suitable securing means, such as a screw, pin or rod can be used to secure the floor stand mount (32) to the base (4). The floor stand mount (32) includes a receiving means for a pole (36). The pole should have a shape that corresponds to the shape of the receiving means to permit pole to be inserted and removed from the receiving means.

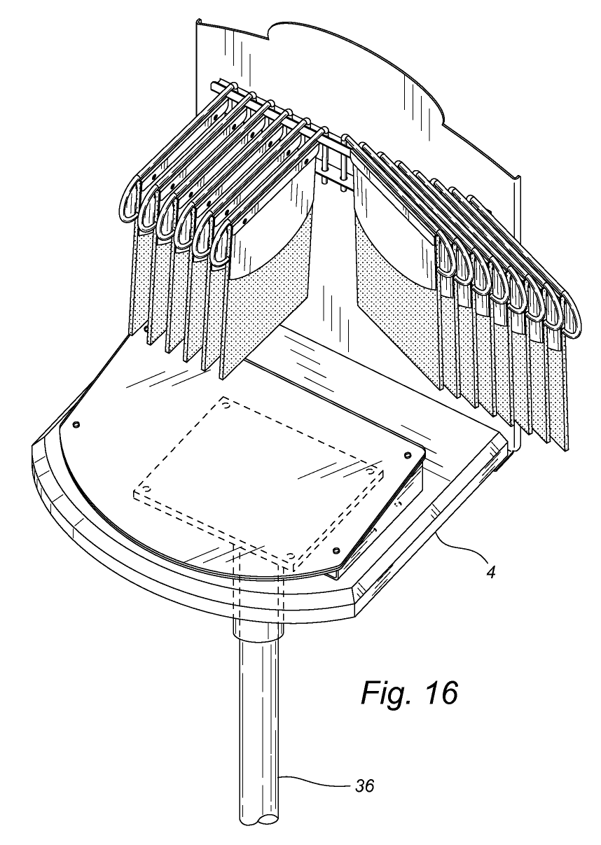

FIG. 16 is a view of the display device suitable for a floor stand according to principles of the present invention. In this figure, a pole (36) is attached to the base (6) via the floor stand mount (32). The pole (36) can connect to any suitable pole stand known to a person of the ordinary skill in the art.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A display comprising:
a base;
a backboard attached to the base;
a bracket mount attached to the front side of the backboard; and
at least one removable bracket attached to the bracket mount.

2. The display according to claim 1 further comprising an information panel display attached to the upper surface of the base.

3. The display according to claim 2 wherein in the information panel display is attached to the upper surface of the base with an information panel mount.

4. The display according to claim 3, wherein the information panel mount has an incline effective to display the information panel display at an angle relative to the upper surface of the base.

5. The display according to claim 2, wherein an information graphic is attached to the information panel display.

6. The display according to claim 5, wherein the information graphic is removably attached to the information panel display.

7. The display according to claim 1 wherein the bracket further comprises a sample holder configured to hold a sample.

8. The display according to claim 7, wherein the sample holder is configured to hold a sample and a literature panel.

9. The display according to claim 1 wherein the base further comprises:
a floor stand mount attached to the underside of the base;
a receiving means for a pole attached to the floor stand mount;
a pole held by the receiving means; and
a floor pedestal connected to the floor stand mount via the pole.
